(19) United States
(12) Patent Application Publication
(10) Pub. No.: US 2016/0040751 A1
(43) Pub. Date: Feb. 11, 2016

(54) SILENT CHAIN TRANSMISSION DEVICE

(71) Applicant: TSUBAKIMOTO CHAIN CO., Osaka-shi (JP)

(72) Inventors: Toshifumi Sato, Osaka-shi (JP); Takeo Sasaki, Osaka-shi (JP); Shuji Hamaguchi, Osaka-shi (JP)

(73) Assignee: TSUBAKIMOTO CHAIN CO., Osaka-shi (JP)

(21) Appl. No.: 14/817,519

(22) Filed: Aug. 4, 2015

(30) Foreign Application Priority Data
Aug. 6, 2014 (JP) 2014-160842

(51) Int. Cl. F16G 13/04; F16G 15/02

(52) U.S. Cl. CPC F16G 13/04; F16G 15/02

(57) ABSTRACT

An object of the present invention is to provide a silent chain transmission device which stabilizes chain behavior during chain travel to suppress an occurrence of tooth skipping and reduces a string vibration sound and a meshing noise with a simple configuration. In a silent chain transmission device 100 made up of a silent chain 110 and a sprocket 180, a pitch between rolling points I of locker pins 170 of front and rear pin holes 161 of a non-guide row 150 is set equal to a sprocket pitch S in a state where the silent chain 110 is wound around the sprocket 180 under a low load.

### BACKGROUND OF THE INVENTION

1. Field of the Invention

The present invention relates to a silent chain transmission device made up of a silent chain and a sprocket.

2. Description of the Related Art

Conventionally, a silent chain is known in which a guide row made up of a pair of left and right guide plates and a middle plate disposed between the pair of left and right guide plates and a non-guide row made up of a plurality of inner plates are alternately connected in a chain longitudinal direction by a pair of locker pins made up of a long pin and a short pin to be inserted into a pair of front and rear pin holes provided on the middle plate and the inner plates (for example, refer to Japanese Patent Application Laid-open No. 2002-130384).

In addition, a silent chain transmission device is known which is capable of transmitting power among a plurality of sprockets by winding a silent chain around the plurality of sprockets.

Generally, in a silent chain transmission device made up of a silent chain and a sprocket, a sprocket pitch is defined as an interval between intersections of a standard pitch line of the sprocket and an imaginary line that passes through respective tooth bottoms.

In addition, tooth shapes of the sprocket and shapes of the respective plates of the silent chain are designed so that the silent chain can be wound around the sprocket in an optimal manner in a state where a pitch between rolling points that are an interval between rolling points of a pair of locker pins inserted into respective pin holes of the silent chain is consistent with the sprocket pitch.

Presupposing the occurrence of elastic elongation and wear elongation, a known silent chain such as that described in Japanese Patent Application Laid-open No. 2002-130384 is designed such that a pitch between rolling points in at least a non-guide row is smaller than a sprocket pitch in a low load state where the silent chain is subjected to such a load that elastic elongation hardly occurs as shown in the table in FIG. 5.

This design takes into consideration that, when elastic elongation and wear elongation occur during actual use, a difference between the sprocket pitch and the pitch between rolling points decreases and winding of the silent chain around the sprocket improves.

### SUMMARY OF THE INVENTION

However, when a pitch relationship is set as described above, since the pitch between rolling points in at least the non-guide row becomes shorter than the sprocket pitch in the silent chain wound around the sprocket in an initial state and a low load state where wear elongation has not occurred, winding around the sprocket loosens.

As a result, a problem occurs where, due to unstable chain behavior, a string vibration sound of the silent chain becomes louder and a meshing noise between the silent chain and the sprocket worsens.

In addition, even when a high load that causes elastic elongation is applied to the silent chain, there is a region where the silent chain is wound without being subject to tension from the sprocket or, in other words, a region where the silent chain is wound around the sprocket by the weight of the silent chain as well as in a region where a load acting on the silent chain decreases on the sprocket. In such regions, since the pitch between rolling points in at least the non-guide row becomes shorter than the sprocket pitch and, similarly, winding of the silent chain around the sprocket loosens and chain behavior is not stable, there is a problem that a string vibration sound of the silent chain becomes louder and a meshing noise between the silent chain and the sprocket worsens.

Furthermore, in a high load region where the silent chain is wound while being subject to tension from the sprocket, a force is applied in a direction in which the pitch between rolling points decreases due to strong elasticity and generates a force in a direction in which the silent chain detaches from the teeth of the sprocket. This makes it easier for link teeth of the inner plate to run on the sprocket teeth and creates a risk of so-called tooth skipping.

Moreover, even in the guide row, presupposing the occurrence of elongation of the silent chain, since the pitch between rolling points is set equal to or shorter than the sprocket pitch in a low load state so as to improve winding of the silent chain around the sprocket when elongation occurs as shown in the table in FIG. 5, there is a similar problem to that of the non-guide row described above.

To describe the “pitch between rolling points” and the “sprocket pitch” discussed above in greater detail, the “pitch between rolling points” refers to an interval between pin rolling points that are adjacent to each other in a chain longitudinal direction, a pin rolling point being a point where rolling surfaces of a pair of locker pins inserted into pin holes of a middle plate and an inner plate abut against each other in a state where the silent chain is wound around the sprocket in a low load state.

In addition, the “sprocket pitch” refers to an interval between imaginary intersections that are adjacent to each other in the chain longitudinal direction, an imaginary intersection being an intersection of a pitch line which passes through each pin rolling point and which extends in the chain longitudinal direction and an imaginary line which passes through a center of rotation of the sprocket and each tooth bottom of the sprocket.

The present invention solves these problems and an object thereof is to provide a silent chain transmission device which stabilizes chain behavior during chain travel to suppress an occurrence of tooth skipping and which reduces a string vibration sound and a meshing noise with simple configurations.

A silent chain transmission device according to the present invention solves the problems described above by being configured as a silent chain transmission device made up of a silent chain and a sprocket, wherein the silent chain is configured such that a guide row made up of a pair of left and right guide plates and a middle plate disposed between the pair of left and right guide plates and a non-guide row made up of a plurality of inner plates are alternately connected in a chain longitudinal direction by a pair of locker pins made up of a long pin and a short pin to be inserted into a pair of front and rear pin holes provided on the middle plate and the inner plates, and a pitch between rolling points of the locker pins of the front and rear pin holes of the non-guide row is set equal to a sprocket pitch in a state where the silent chain is wound around the sprocket under a low load.

With the silent chain transmission device according to the present invention, due to the pitch between rolling points in the non-guide row being set equal to the sprocket pitch in a state where the silent chain is wound around the sprocket under a low load, the pitch between rolling points in the non-guide row becomes equal to the sprocket pitch when the silent chain is in an initial state and a low load state.

Accordingly, winding of the silent chain around the sprocket is improved, chain behavior during chain travel becomes stable, and a string vibration sound and a meshing noise of the silent chain can be reduced.

In addition, even when a high load is applied to the silent chain or wear elongation occurs in the silent chain, the pitch between rolling points in the non-guide row becomes equal to the sprocket pitch in a region where the silent chain is wound without being subject to tension from the sprocket or, in other words, a region where the silent chain is wound around the sprocket by the weight of the silent chain as well as in a region where a load acting on the silent chain decreases on the sprocket.

Accordingly, winding of the silent chain around the sprocket is improved, chain behavior during chain travel becomes stable, a string vibration sound and a meshing noise of the silent chain can be reduced, and an occurrence of tooth skipping can be suppressed even in a high load region where the silent chain is wound while being subject to tension from the sprocket.

With the configuration according to present claim 2, due to the pitch between rolling points in the guide row being set equal to the sprocket pitch in a state where the silent chain is wound around the sprocket under a low load, the pitch between rolling points in the guide row becomes equal to the sprocket pitch when the silent chain is in an initial state and a low load state.

Accordingly, a similar effect to that of the non-guide row is also created in the guide row, causing winding of the silent chain around the sprocket to be improved in the silent chain as a whole, chain behavior during chain travel to be stable, a string vibration sound and a meshing noise of the silent chain to be reduced, and an occurrence of tooth skipping to be suppressed even in a high load region where the silent chain is wound while being subject to tension from the sprocket.

With the configuration according to present claim 3, due to the thickness of the short pin of the pair of locker pins in the chain longitudinal direction being different from the thickness of the long pin in the chain longitudinal direction, the pitch between rolling points can set equal to the sprocket pitch without having to change positions of the pin holes of the respective plates from conventional pin holes.

With the configuration according to present claim 4, due to the positions of the front and rear pin holes of the non-guide row being different from positions of the front and rear pin holes of the guide row, the pitch between rolling points of the locker pins of the front and rear pin holes of the non-guide row can be set equal to the sprocket pitch without having to change the pair of locker pins, the guide plates, and the middle plate from those that are conventional.

With the configuration according to present claim 5, due to the pitch between rolling points being different between the guide row and the non-guide row, a timing and a position of contact with the sprocket changes between the middle plate and the inner plates. As a result, periodic noise and vibration are suppressed and, furthermore, a string vibration sound and a meshing noise can be reduced.

### BRIEF DESCRIPTION OF THE DRAWINGS

FIG. 1 is a partial side view of a silent chain transmission device according to a first embodiment of the present invention;

FIG. 2 is a sectional explanatory diagram of a silent chain of a silent chain transmission device according to the first embodiment of the present invention;

FIG. 3 is a relationship explanatory diagram of a silent chain and a sprocket of a silent chain transmission device according to the first embodiment of the present invention;

FIG. 4 is a relational table of respective pitches of the a silent chain transmission device according to the first embodiment of the present invention; and

FIG. 5 is a relational table of respective pitches of a conventional silent chain transmission device.

### DESCRIPTION OF THE PREFERRED EMBODIMENTS

The present invention provides a silent chain transmission device made up of a silent chain and a sprocket, wherein the silent chain is configured such that a guide row made up of a pair of left and right guide plates and a middle plate disposed between the pair of left and right guide plates and a non-guide row made up of a plurality of inner plates are alternately connected in a chain longitudinal direction by a pair of locker pins made up of a long pin and a short pin to be inserted into a pair of front and rear pin holes provided on the middle plate and the inner plates, and a pitch between rolling points of the locker pins of the front and rear pin holes of the non-guide row is set equal to a sprocket pitch in a state where the silent chain is wound around the sprocket under a low load. The silent chain transmission device can assume any specific embodiment as long as the silent chain transmission device stabilizes chain behavior during chain travel, suppresses an occurrence of tooth skipping, and reduces a string vibration sound and a meshing noise with a simple configuration.

Any specific material may be used for the respective components of the silent chain according to the present invention as long as the material has sufficient strength to maintain tension of the chain at a proper level. From the perspectives of strength, workability, and economic efficiency, an iron-based material such as steel and cast iron is favorably used. In particular, the guide plates, the middle plate, and the inner plates are favorably formed by punching out steel plates.

Hereinafter, a silent chain according to an embodiment of the present invention will be described with reference to the drawings.

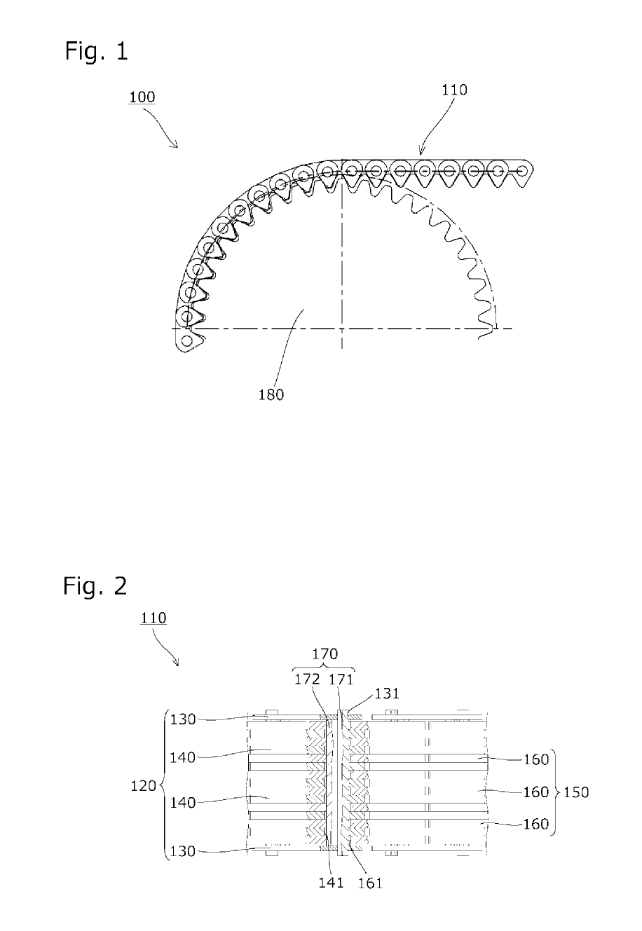

As partially shown in FIG. 1, a silent chain transmission device 100 according to a first embodiment of the present invention is made up of a silent chain 110 and a sprocket 180.

As shown in FIG. 2, in the silent chain 110, a plurality of guide rows 120 and a plurality of non-guide rows 150 are alternately arranged in a chain longitudinal direction while being staggered by half a pitch, and bendably connected by a pair of locker pins 170.

The guide rows 120 are made up of a pair of left and right guide plates 130 that are arranged on both outer sides in a chain width direction and a plurality of middle plates 140 that are arranged between the pair of left and right guide plates 130. In addition, the non-guide rows 150 are made up of a plurality of inner plates 160 that are arranged parallel to each other in the chain width direction.

The pair of locker pins 170 is made up of a long pin 171 and a short pin 172. While the long pin 171 and the short pin 172 are pins with a same shape and different lengths, in an alternative example, the long pin 171 and the short pin 172 may be pins with different sectional shapes on a plane that is perpendicular to the chain width direction.

The long pin 171 and the short pin 172 are inserted together into a pin hole 141 of the middle plate 140 and a pin hole 161 of the inner plate 160 in a loosely fitting state, and both ends of the long pin 171 are fixed to pin holding holes 131 of the guide plate 130.

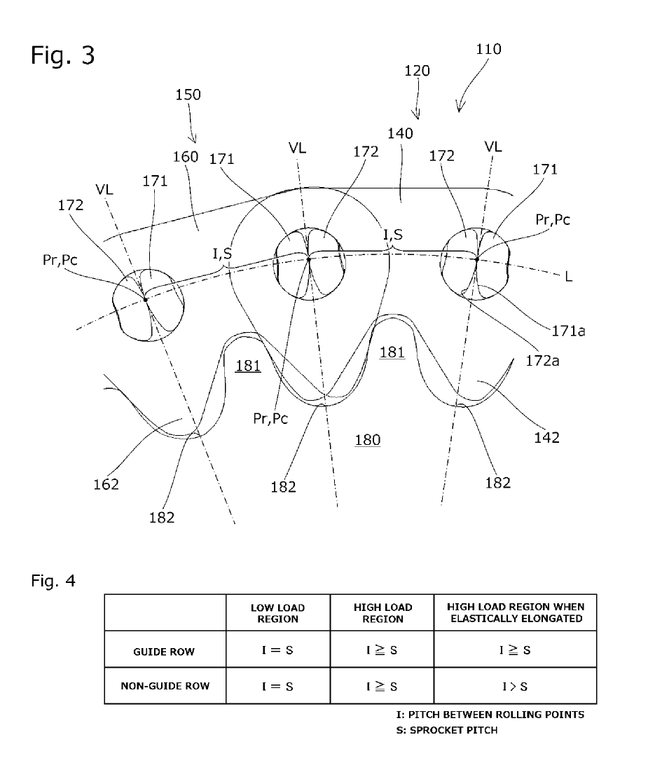

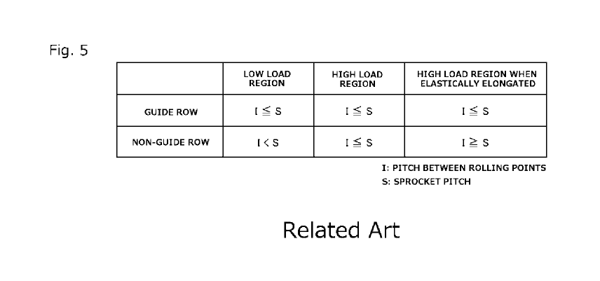

As shown in FIG. 3, the long pin 171 and the short pin 172 respectively include rolling surfaces 171a and 172a formed on an inner side in a chain longitudinal direction and a recessed back surface formed on an outer side in the chain longitudinal direction, and the pin hole 141 of the middle plate 140 and the pin hole 161 of the inner plate 160 include a projecting seat surface which is formed on an outer side in the chain longitudinal direction and which restricts pin attitude. The long pin 171 and the short pin 172 are inserted into the pin holes 141 and 161 in a state where the respective rolling surfaces 171a and 172a oppose each other and the respective back surfaces of the pins 171 and 172 are seated on the seat surfaces of the pin holes 141 and 161.

The middle plate 140 and the inner plate 160 respectively include a pair of V-shaped link teeth 142 and 162 to mesh with sprocket teeth 181 of the sprocket 180 on a sprocket meshing side.

Next, a pitch relationship among respective members of the silent chain transmission device 100 will be described.

First, in the present embodiment, a pitch between rolling points I in the guide row 120 and the non-guide row 150 is set equal to a sprocket pitch S as shown in the table in FIG. 4 in a state where the silent chain 110 is wound around the sprocket 180 in a low load state.

In this case, as shown in FIG. 3, the pitch between rolling points I described above refers to an interval between pin rolling points Pr that are adjacent to each other in a chain longitudinal direction, a pin rolling point Pr being a rolling point between the pair of locker pins 170 inserted into the pin holes 141 and 161 of the middle plate 140 and the inner plate 160 in a state where the silent chain 110 is wound around the sprocket 180 in a low load state.

The sprocket pitch S described above refers to an interval between imaginary intersections Pc that are adjacent to each other in the chain longitudinal direction, an imaginary intersection Pc being an intersection of a pitch line L which passes through each pin rolling point Pr and which extends in the chain longitudinal direction and an imaginary line VL which passes through a center of rotation (not shown) of the sprocket 180 and each tooth bottom 182 of the sprocket 180.

By setting a pitch relationship among respective members of the silent chain transmission device 100 as described above, the pitch between rolling points I in the guide row 120 and the non-guide row 150 becomes equal to the sprocket pitch S when the silent chain 110 is in an initial state and a low load state, and even when a high load is applied to the silent chain 110 or when wear elongation occurs in the silent chain 110, the pitch between rolling points I becomes equal to the sprocket pitch S in a region where the silent chain 110 is wound around the sprocket 180 due to weight or a region where a load acting on the silent chain 110 decreases on the sprocket 180.

Specific configurations that enable the pitch relationship among respective members to be set as described above will now be listed.

In a first specific example, a size and a shape of the short pin 172 that determines the pitch between rolling points I in the non-guide row 150 are adjusted in order to adjust a relationship between the pitch between rolling points I and the sprocket pitch S in the non-guide row 150.

In this case, the sprocket 180 which has a same configuration as a conventional sprocket can be used without modification, and parts of the silent chain 110 with the exception of the short pin 172 can also be used without modification.

In a second specific example, a tooth shape of the sprocket 180 is adjusted in order to adjust a relationship between the pitch between rolling points I and the sprocket pitch S in the guide row 120 and the non-guide row 150.

In this case, the silent chain 110 which has a same configuration as a conventional silent chain can be used without modification, and the relationship between the pitch between rolling points I and the sprocket pitch S can be adjusted for both the guide row 120 and the non-guide row 150.

In a third specific example, formation positions of the pin holes 141 and 161 of the middle plate 140 and the inner plate 160 and a formation position of the pin holding holes 131 of the guide plate 130 are adjusted in order to adjust a relationship between the pitch between rolling points I and the sprocket pitch S in the guide row 120 and the non-guide row 150.

In this case, the sprocket 180 which has a same configuration as a conventional sprocket can be used without modification, and parts of the silent chain 110 with the exception of the plates 130, 140, and 160 can also be used without modification.

Moreover, the specific examples listed above may respectively be adopted independently or a plurality of the specific examples maybe combined as appropriate. Alternatively, specific examples maybe realized by configurations other than those described above.

While embodiments of the present invention have been described above in detail, it is to be understood that the present invention is not limited to the embodiments described above and that various design changes can be made without departing from the spirit and scope of the invention as set forth in the appended claims.

For example, while a pitch between rolling points is set equal to a sprocket pitch in both a non-guide row and a guide row in a state where a silent chain is wound around a sprocket in a low load state in the embodiments described above, the pitch between rolling points may be set equal to the sprocket pitch only in the non-guide row.

What is claimed is:

1. A silent chain transmission device made up of a silent chain and a sprocket, wherein
the silent chain is configured such that a guide row made up of a pair of left and right guide plates and a middle plate disposed between the pair of left and right guide plates and a non-guide row made up of a plurality of inner plates are alternately connected in a chain longitudinal direction by a pair of locker pins made up of a long pin and a short pin to be inserted into a pair of front and rear pin holes provided on the middle plate and the inner plates, and
a pitch between rolling points of the locker pins of the front and rear pin holes of the non-guide row is set equal to a sprocket pitch in a state where the silent chain is wound around the sprocket under a low load.

2. The silent chain transmission device according to claim 1, wherein a pitch between rolling points of the locker pins of the front and rear pin holes of the guide row is set equal to the sprocket pitch in a state where the silent chain is wound around the sprocket under a low load.

3. The silent chain transmission device according to claim 1, wherein a thickness of the short pin of the pair of locker pins in the chain longitudinal direction differs from a thickness of the long pin in the chain longitudinal direction.

4. The silent chain transmission device according to claim 1, wherein positions of the front and rear pin holes of the non-guide row differ from positions of the front and rear pin holes of the guide row.

5. The silent chain transmission device according to claim 1, wherein a pitch between rolling points of the locker pins of the front and rear pin holes of the non-guide row differs from a pitch between rolling points of the locker pins of the front and rear pin holes of the guide row.
